(19) United States
(12) Patent Application Publication
(10) Pub. No.: US 2014/0108046 A1
(43) Pub. Date: Apr. 17, 2014

(54) SHARING HEALTHCARE INFORMATION ON PRIVATE COLLABORATIVE NETWORKS

(71) Applicants: Ruben Gerardo Echeverria Cabrera, Yucatan (MX); Hugo Luis Villalobos Canto, Van Nuys, CA (US); Luis Alberto Munoz Ubando, Yucatan (MX); Jorge Carolos Borges Ku, Yucatan (MX); Juan Alberto Marin Caamal, Yucatan (MX)

(72) Inventors: Ruben Gerardo Echeverria Cabrera, Yucatan (MX); Hugo Luis Villalobos Canto, Van Nuys, CA (US); Luis Alberto Munoz Ubando, Yucatan (MX); Jorge Carolos Borges Ku, Yucatan (MX); Juan Alberto Marin Caamal, Yucatan (MX)

(21) Appl. No.: 13/800,619

(22) Filed: Mar. 13, 2013

Related U.S. Application Data
(60) Provisional application No. 61/713,382, filed on Oct. 12, 2012.

(51) Int. Cl. G06F 19/00

(52) U.S. Cl. CPC G06F 19/322
USPC 705/3

(57) ABSTRACT

The present invention extends to methods, systems, and computer program products for sharing healthcare information in private collaborative networks. A hierarchy of rules includes patient rules for each of one or more patients. For each patient, the patient rules define a private collaborative network for sharing healthcare information related to the patient among a plurality of designated entities. A computer stores healthcare information related to the one or more patients. The computer receives request from entities requesting access to stored healthcare information related to the one or more patients. The computer refers to patient's rules within the hierarchy of rules to determine what, if any, subset of the patient's stored healthcare information is accessible to the requesting entity. The computer provides accessible subsets of stored healthcare information to the requesting entity in accordance with the patient rules.

### CROSS-REFERENCE TO RELATED APPLICATIONS

The present application claims the benefit of and priority to U.S. Provisional Application No. 61/713,382, entitled “Sharing Healthcare Information on Private Collaborative Networks,” filed on Oct. 12, 2012, the entirety of which is incorporated herein by this reference.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

In some environments, healthcare information related to patients is stored in electronic format on network computer systems. Healthcare information related to a patient can include a variety of different types of data including, but not limited to: physiological data, prescription medicine data, medicine intake data, and electronic medical record data. Although healthcare information is often stored electronically, healthcare information is typically available only to healthcare providers and only in pre-designated formats on an all or none basis.

Unfortunately, a patient typically has no way to efficiently control dissemination of his or her healthcare information. Further, a patient has limited, if any, ability to compartmentalize the distribution of his or her healthcare information on a more granular level. Thus, a patient may have no way to send different parts of his or her healthcare information to different entities. For example, a patient typically has no way to make one portion of his or her healthcare information available to a family member and another different portion of his or her healthcare information available to a healthcare provider.

In some environments, electronic medical appliances are used to take physiological measurements for a patient. Patients with certain disease states, such as heart failure, diabetes, etc., are likely to own and use more than one of these medical appliances. These medical appliances include, but are not limited to, home blood pressure cuffs, heart rate monitors, pulse oximeters, blood glucose monitors, weight scales, and other appliances. The medical appliances can collect and temporarily store information, such as, for example, systolic and diastolic pressure, pulse rate, blood glucose levels, and patient weight.

Many electronic medical appliances include communication ports and software to connect them to a computer. As such, physiological information can be collected from multiple home medical devices and transferred to a computer. The physiological information is then available to both patients and their healthcare providers (e.g., via the Internet).

However, mechanisms for transferring physiological information to a computer can be cumbersome for a patient. The patient must have some level of technical competence to use the medical appliances, connect medial appliances to a computer, and utilize software to transfer physiological information to the computer. Individual medical appliances can also vary greatly in configuration, such as, data formats and communication protocols used to interface with a computer (even when the medical appliances are produced by the same manufacturer). Thus, a patient may have several different cables to connect to his or her computer and may also have to run different software to communicate with each different medical appliance.

For some patients there may also be a cost barrier. For example, a patient may not be able to afford a computer to store his or her physiological information.

There are also difficulties related to patient compliance. Since collected physiological information can be an indication of serious medical conditions, declining health, failure to take medication, etc., patients may be reluctant to use medical appliances to collect physiological information. If collected physiological information in fact indicates a medical difficulty, the patient may likewise be reluctant to transfer the physiological information to a computer for access by a healthcare provider. Thus, even if a patient has the correct equipment and technical competence, the patient may choose not to collect his or her physiological information or make that physiological information available to healthcare providers.

Additionally, due to the potentially significant level of human interaction with medical appliances, computers, and connections therebetween during the collection process, there is always the possibility for human error in the collection and/or transfer of physiological data.

### BRIEF SUMMARY

The present invention extends to methods, systems, and computer program products for sharing healthcare information on private collaborative networks. Healthcare information related to an individual is stored at the computer system. Healthcare information can include physiological data, prescription medicine data, medicine intake data, electronic medical record data, etc. The computer system receives a first computer network communication requesting access to stored healthcare information related to the individual. The first computer network communication corresponds to a first entity selected from among a plurality of designated entities (e.g., family members, healthcare providers, etc.) associated with the individual.

The computer system refers to a hierarchy of rules in response to receiving the first computer network communication. The hierarchy of rules defines a private collaborative network for the individual by defining how the stored healthcare information can be shared among the plurality of designated entities. The hierarchy of rules indicates that a least a first subset of the healthcare information is accessible to the first entity. The at least a first subset of the healthcare information is provided to the first entity in accordance with the hierarchy of rules.

The computer system receives a second computer network communication requesting access to stored healthcare information related to the individual. The second computer network communication corresponds to a second different entity selected from among the plurality of designated entities. The computer system refers to the hierarchy of rules in response to receiving the second computer network communication. The hierarchy of rules further indicates that a least a second different subset of the healthcare information is accessible to the second entity. The at least a second subset of the healthcare information is provided to the second entity in accordance with the hierarchy of rules.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out herein. These and other features of the present invention will become more fully apparent from the following description, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates sharing healthcare information on private collaborative networks.

FIG. 2 illustrates another example computer architecture that facilitates sharing healthcare information on private collaborative networks.

FIG. 3 illustrates a flow chart of an example method for sharing healthcare information on private collaborative networks.

### DETAILED DESCRIPTION

The present invention extends to methods, systems, and computer program products for sharing healthcare information on private collaborative networks. Healthcare information related to an individual is stored at the computer system. Healthcare information can include physiological data, prescription medicine data, medicine intake data, electronic medical record data, etc. The computer system receives a first computer network communication requesting access to stored healthcare information related to the individual. The first computer network communication corresponds to a first entity selected from among a plurality of designated entities (e.g., family members, healthcare providers, etc.) associated with the individual.

The computer system refers to a hierarchy of rules in response to receiving the first computer network communication. The hierarchy of rules defines a private collaborative network for the individual by defining how the stored healthcare information can be shared among the plurality of designated entities. The hierarchy of rules indicates that at least a first subset of the healthcare information is accessible to the first entity. The at least first subset of the healthcare information is provided to the first entity in accordance with the hierarchy of rules.

The computer system receives a second computer network communication requesting access to stored healthcare information related to the individual. The second computer network communication corresponds to a second different entity selected from among the plurality of designated entities. The computer system refers to the hierarchy of rules in response to receiving the second computer network communication. The hierarchy of rules further indicates that a least a second different subset of the healthcare information is accessible to the second entity. The at least second subset of the healthcare information is provided to the second entity in accordance with the hierarchy of rules.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter of the invention has been described in language specific to structural features and/or methodological acts, it is to be understood that the subject matter defined herein is not necessarily limited to the specific features or acts described above. Rather, the described features and acts are disclosed as example forms of implementing the embodiments described herein.

Those skilled in the art will appreciate that the invention may be practiced in network computing environments with many types of computer system configurations, including, but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. As used herein, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

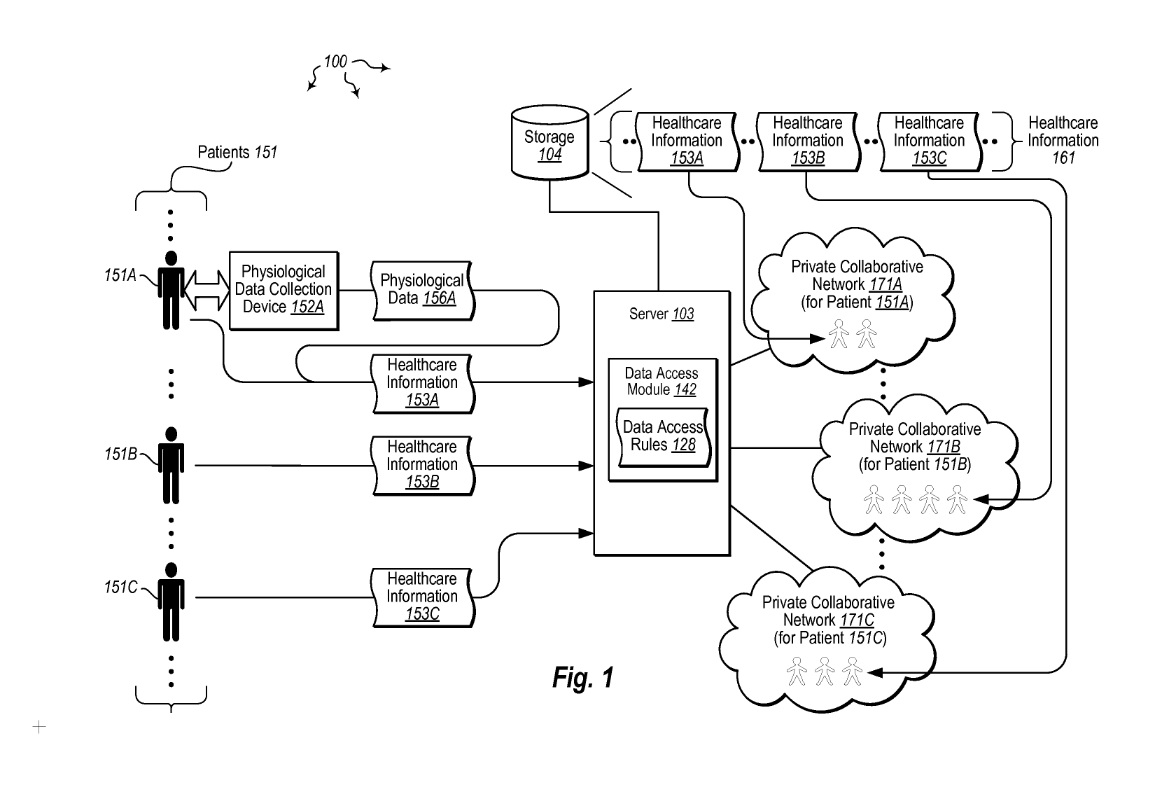

FIG. 1 illustrates an example computer architecture 100 that facilitates sharing healthcare information on private collaborative networks. Referring to FIG. 1, computer architecture 100 includes server 103 and storage 104. Each of the depicted components is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Server 103 includes data access module 142. Data access module 142 is configured to control third-party access to patient healthcare information 161 stored in storage 104. Healthcare information 161 can include physiological data, prescription medicine data, medicine intake data, electronic medical record data, heart rate data, and other data related to the health of a patient. Patient healthcare information can originate from a variety of sources, including: the patient, healthcare providers, family members, healthcare institutions, pharmacies, etc. Any of these sources can provide healthcare information related to patients 151 to server 103. For example, these sources can provide healthcare information 153A, 153B, and 153C for patients 151A, 151C, and 151C respectively.

In some embodiments, physiological data collection devices are also used to provide healthcare information related to a patient. For example, physiological data collection device 152A can collect physiological data 156A (e.g., blood glucose data, heart rate data, Electrocardiography (“EKG”) data, weight data, temperature data, body mass data, and bone density data, and any other data related to the health of the patient) for patient 151A. Physiological data 156A can be included with healthcare information 153A for patient 151A.

Provided healthcare information, including healthcare information 153A, 153B, and 153C, can be stored in storage 104.

Data access module 142 maintains data access rules 128. Data access rules 128 can contain data access rules for a plurality of patients, including patients 151. For each of the plurality of patients, data access rules 128 defines what portion of the patient's healthcare information 161 is accessible to one or more designated entities. For example, for each of patients 151A, 151B, and 151C, data access rules 128 can define what portions of healthcare information 153A, 153B, and 153C respectively are available to designated entities. Designated entities can include: family members, friends, healthcare providers, healthcare institutions (hospitals, clinics, skilled care facilities, etc.), laboratories, insurance providers, etc.

Patients can interact with server 103 to control access to their healthcare information. Server 103 can include a patient interface (e.g., a Web based patient user interface) that patients can use to configure rules for accessing their healthcare information. Patients can use the patient interface to give different designated entities access to different portions of their healthcare information. Setting up access to a patient's healthcare information essentially defines a private collaborative network for the patient. For example, patient 151A can configure access to healthcare information 153A to define private collaborative network 171A. Similarly, patient 151B can configure access to healthcare information 153B to define private collaborative network 171B. Likewise, patient 151C can configure access to healthcare information 153C to define private collaborative network 171C.

Within a private collaborative network, designated entities can collaborate, based on healthcare information available to them, to assist with a patient's care. For example, within private collaborative network 171A, a family member and doctor can collaborate to provide care for patient 151A, based on portions of healthcare information 153A available to each of the family member and the doctor.

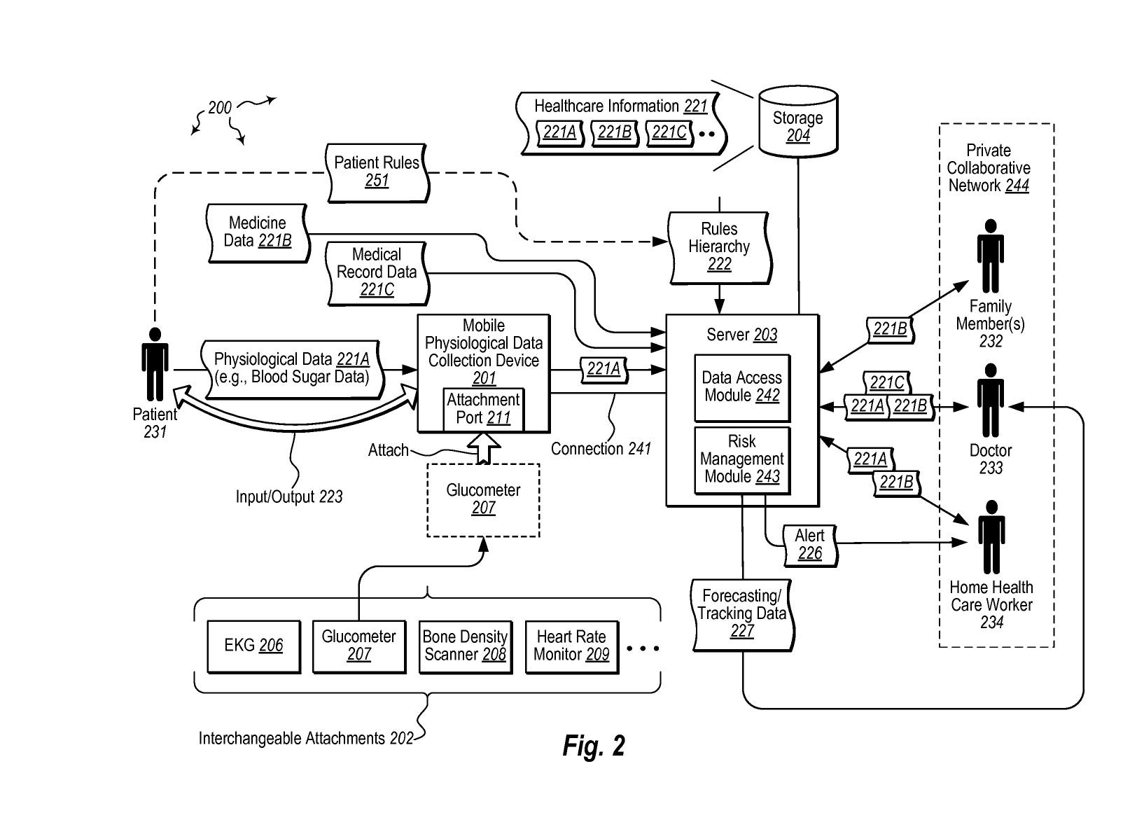

FIG. 2 illustrates an example computer architecture 200 that facilitates sharing healthcare information on private collaborative networks. Referring to FIG. 2, computer architecture 200 includes mobile physiological collection device 201, server 203, and storage 204. Each of the depicted devices and components is connected to one another over (or is part of) a network, such as, for example, a Local Area Network (“LAN”), a Wide Area Network (“WAN”), the Internet or other networks. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

As depicted, server 203 includes data access module 242 and risk management module 243. Data access module 242 is configured to control third-party access to patient healthcare information stored in storage 204. Risk management module 243 is configured to analyze patient healthcare information. Risk management module 243 can determine if healthcare information related to a patient satisfies any risk management criteria for the patient. Risk management module 243 can automatically send a notification to a corresponding specified entity when it is determined that risk management criteria is satisfied. Risk management module 243 can also provide forecasting/tracking data for a patient. Forecasting/tracking data can be used to prevent a risk management event prior to occurrence. For example, if a diabetic patient's blood sugar has been trending up for some period of time, the patient's insulin can be increased to prevent hyperglycemic related conditions.

In general, storage 204 can store healthcare information related to patients. For example, storage 204 can store healthcare information 221 for patient 231. Healthcare information 221 can include physiological data 221A, medicine data 221B, medical record data 221C or other healthcare related information. Medicine data 221B can include prescription medicine data and/or medicine intake data. In some embodiments, physiological data 221A can be collected by mobile physiological collection device 201.

Mobile physiological collection device 201 includes attachment port 211. Attachment port 211 can accept any of a variety of interchangeable attachments 202 for collecting different types of physiological data, such as, for example, electrocardiogram data, blood sugar data, bone density data, heart rate data, etc. As depicted, interchangeable attachments 202 can include EKG 206, glucometer 207, bone density scanner 208, and heart rate monitor 209. When an interchangeable attachment is attached to attachment port 211, mobile physiological collection device 201 changes to the functionality of the interchangeable attachment. For example, when glucometer 207 is attached to attachment port 111, mobile physiological collection device 201 gains the ability to obtain blood sugar data for a patient (e.g., patient 231).

Mobile physiological data collection device 201 can also include a processor, system memory, a storage device, a network interface, and a user interface. Computer-executable instructions can run on the processor to implement general and/or special purpose processing capabilities. Implemented processing capabilities can include obtaining physiological data from an interchangeable attachment, storing obtained physiological data (e.g., in the storage device), and providing stored physiological data over a connection to a server. Through the user interface, a patient can calibrate mobile physiological data collection device 201 and can configure mobile physiological data collection device 201 to collect physiological data, download physiological data from an interchangeable attachment to system memory and/or the storage device, and transfer physiological data to a server. For example, patient 231 can enter and observe input/output 223 to calibrate and configure mobile physiological data collection device 201.

Mobile physiological collection device 201 can be (e.g., intermittently) connected to server 203 via connection 241. Connection 241 can be cellular or TCP/IP connection, wireless or wired or a combination of these or other connectivity schemes. During connection 241, mobile physiological collection device 201 can use the network interface to transfer collected physiological data to server 203.

In general, access to a patient's healthcare information can be defined in rules hierarchy 222. For example, rules hierarchy 222 can include data access rules as well as risk management criteria for a plurality of patients, including patient 231. A patient can define individual patient rules to control access to his or her healthcare information. Definition of patient rules essentially defines a private collaborative network for the patient.

For example, patient 231 can define patient rules 251 to control access to healthcare information 221. Patient rules 251 can be merged into rules hierarchy 222. Patient rules 251 can define private collaborative network 244 that permits family member(s) 232 access to medicine data 221B, permits doctor 233 to access physiological data 221A, medicine data 221B, and medical record data 221C, and permits home healthcare work 234 to access physiological data 221A and medicine data 221B. As such, family member(s) 232, doctor 233, and home healthcare worker 234 can collaborate in the care and treatment of patient 231 to the extent they are aware of patient 231's healthcare information. For example, family member(s) 232 can determine can access medicine intake data for patient 231. Medicine intake data can indicate if patient 232 has taken medication. If not, family member(s) 232 can contact home healthcare worker 234 to be sure medication is administered.

Risk management rules in rules hierarchy 222 can be defined by the owner of server 203 and/or by patient healthcare providers. Since patients can have different conditions and can manifest symptoms of the same conditions in different ways, healthcare providers can tailor risk management criteria on a per patient basis. For example, doctor 233 can tailor risk management criteria for patient 231 based on the medical history of patient 231.

Risk management module 243 can monitor healthcare information 221. If healthcare information 221 ever satisfies the defined risk management criteria, alert 226 can be automatically sent to home healthcare worker 234. Based on the healthcare information 221, risk management module 243 can also provide forecasting/tracking data 227 (for patient 231) to doctor 233.

Server 203 can also include a module for medicine sales. A patient can access the module to obtain and/or refill prescriptions.

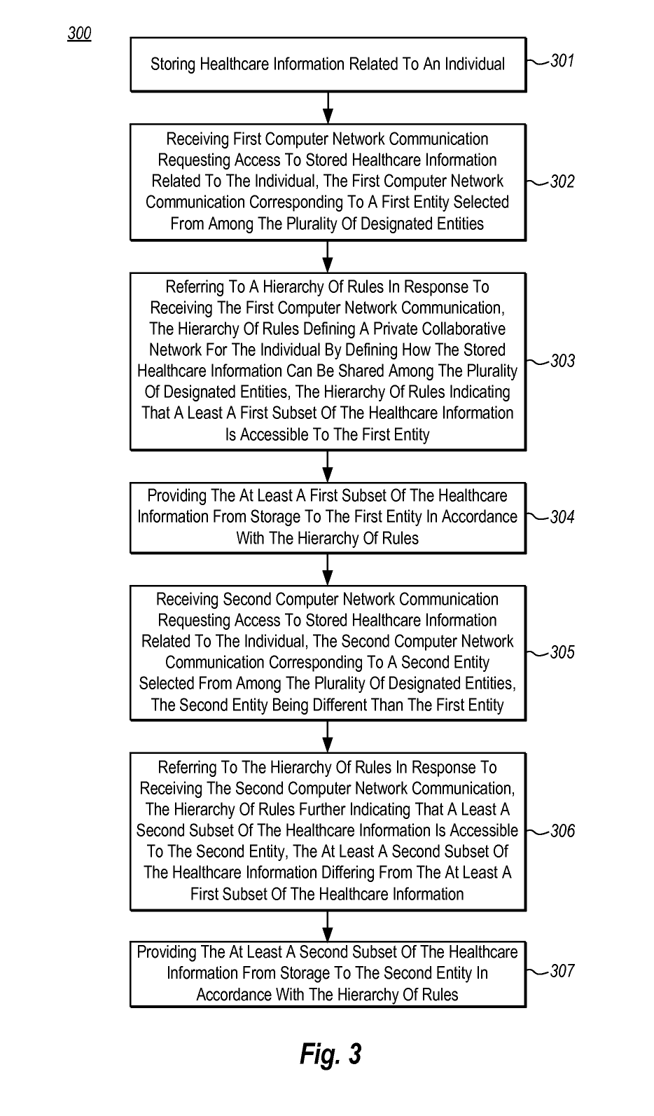

FIG. 3 illustrates a flow chart of an example method 300 for sharing healthcare information on private collaborative networks. Method 300 will be described with respect to the components and data of computer architecture 100.

Method 300 includes an act of storing healthcare information related to the individual at the computer system (act 301). For example, server 203 can store healthcare information 221 in storage 204.

Method 300 includes an act of receiving first computer network communication requesting access to stored healthcare information related to the individual, the first computer network communication corresponding to a first entity selected from among the plurality of designated entities (act 302). For example, server 203 can receive network communication from family member(s) 232. The network communication from family member(s) 232 can request access to healthcare information 221.

Method 300 includes an act of referring to a hierarchy of rules in response to receiving the first computer network communication, the hierarchy of rules defining a private collaborative network for the individual by defining how the stored healthcare information can be shared among the plurality of designated entities, the hierarchy of rules indicating that at least a first subset of the healthcare information is accessible to the first entity (act 303). For example, in response to network communication from family member(s) 232, data access module 242 can refer to patient rules 251 within rules hierarchy 222. Patient rules 251 define private collaborative network 244 by defining how healthcare information 221 can be shared with family member(s) 232, doctor 233, and home healthcare worker 234. Patient rules 251 can indicate that medicine data 221B is accessible to family member(s) 232.

Method 300 includes an act of providing the at least a first subset of the healthcare information from storage to the first entity in accordance with the hierarchy of rules (act 304). For example, server 203 can provide medicine data 221B to family member(s) 232.

Method 300 includes an act of receiving second computer network communication requesting access to stored healthcare information related to the individual, the second computer network communication corresponding to a second entity selected from among the plurality of designated entities, the second entity being different than the first entity (act 305). For example, server 203 can receive network communication from home healthcare worker 234. The network communication from home healthcare worker 234 can request access to healthcare information 221.

Method 300 includes an act of referring to the hierarchy of rules in response to receiving the second computer network communication, the hierarchy of rules further indicating that a least a second subset of the healthcare information is accessible to the second entity, the at least a second subset of the healthcare information differing from the at least a first subset of the healthcare information (act 306). For example, in response to network communication from home healthcare worker 234, data access module 242 can refer to patient rules 251 within rules hierarchy 222. Patient rules 251 can indicate that physiological data 221A and medicine data 221B are accessible to home healthcare worker 234.

Method 300 includes an act of providing the at least a second subset of the healthcare information from storage to the second entity in accordance with the hierarchy of rules (act 307). For example, server 203 can provide physiological data 221A and medicine data 221B to home healthcare worker 234.

Other entities in private collaborative network 244 can also request access to healthcare information 221. For example, doctor 233 can request access to healthcare information 221. In response to a request from doctor 233, data access module 242 can refer to patient rules 251 within rules hierarchy 222. Patient rules 251 can indicate that physiological data 221A, medicine data 221B (e.g., prescription medicine data and/or medicine intake data), and medical record data 221C are accessible to home healthcare worker 234. Server 203 can provide physiological data 221A, medicine data 221B, and medical record data 221C to doctor 233.

Other entities, such as, for example, friends, healthcare institutions (hospitals, clinics, skilled care facilities, etc.), laboratories, insurance providers, etc., can also be included in private collaborative network 244 and can request access to healthcare information 221. Data access module 242 can provide portions of healthcare information 221 to these other entities as indicated in patient rules 251.

The present invention may be embodied in other specific forms without departing from its spirit or essential characteristics. The described embodiments are to be considered in all respects only as illustrative and not restrictive. All changes which come within the meaning and range of equivalency of the described embodiments are to be embraced within their scope.

What is claimed:

1. At a computer system including one or more processors and system memory, a computer-implemented method for collaboratively sharing healthcare information for an individual among a plurality of designated entities, the method comprising:
an act of storing healthcare information for the individual at the computer system;
an act of the computer system receiving first computer network communication requesting access to stored healthcare information for the individual, the first computer network communication corresponding to a first entity selected from among the plurality of designated entities;
an act of referring to a hierarchy of rules in response to receiving the first computer network communication, the hierarchy of rules defining a private collaborative network for the individual by defining how the stored healthcare information can be shared among the plurality of designated entities, the hierarchy of rules indicating that at least a first subset of the healthcare information is accessible to the first entity;
an act of providing the at least a first subset of the healthcare information from storage to the first entity in accordance with the hierarchy of rules;
an act of the computer system receiving second computer network communication requesting access to stored healthcare information for the individual, the second computer network communication corresponding to a second entity selected from among the plurality of designated entities, the second entity being different than the first entity;
an act of referring to the hierarchy of rules in response to receiving the second computer network communication, the hierarchy of rules further indicating that a least a second subset of the healthcare information is accessible to the second entity, the at least a second subset of the healthcare information differing from the at least a first subset of the healthcare information; and
an act of providing the at least a second subset of the healthcare information from storage to the second entity in accordance with the hierarchy of rules.

2. The computer-implemented method of claim 1, wherein storing healthcare information for the individual at the computer system comprises storing one or more of: physiological data, medicine prescription data, medicine intake data, and electronic medical record data for the individual.

3. The computer-implemented method of claim 2, wherein storing one or more of physiological data, medicine prescription data, medicine intake data, and electronic medical record data for the individual comprises storing physiological data for the individual.

4. The computer-implemented method of claim 3, wherein the act of storing physiological data for the individual at the computer system comprises an act of storing one or more of: blood glucose data, heart rate data, Electrocardiography (“EKG”) data, weight data, temperature data, body mass data, and bone density data.

5. The computer-implemented method of claim 3, further comprising prior to storing physiological data for the individual, an act of the computer system receiving the physiological data directly from one or more physiological data collection devices over a communication link, the communication link selected from among: a cellular network and a TCP/IP network.

6. The computer-implemented method as recited in claim 1, wherein an act of receiving first computer network communication comprises an act of receiving a request to access the stored healthcare information from a family member of the individual; and
wherein an act of receiving second computer network communication comprises an act of receiving a request to access the stored healthcare information from a medical care provider of the individual.

7. The computer-implemented method as recited in claim 1, wherein the act of referring to a hierarchy of rules in response to receiving the first computer network communication comprises an act of referring to a hierarchy of rules that define a separate private collaborative network for each of a plurality of individuals that have healthcare information stored at the computer system.

8. A computer program product for use at a computer system, the computer program product for implementing a method for collaboratively sharing healthcare information for an individual among a plurality of designated entities, the computer program product comprising one or more computer storage devices having stored thereon computer-executable instructions that, when executed at a processor, cause the computer system to perform the method, including the following:
store healthcare information for the individual at the computer system;
receive first computer network communication requesting access to stored healthcare information for the individual, the first computer network communication corresponding to a first entity selected from among the plurality of designated entities;
refer to a hierarchy of rules in response to receiving the first computer network communication, the hierarchy of rules defining a private collaborative network for the individual by defining how the stored healthcare information can be shared among the plurality of designated entities, the hierarchy of rules indicating that a least a first subset of the healthcare information is accessible to the first entity;
provide the at least a first subset of the healthcare information from storage to the first entity in accordance with the hierarchy of rules;
receive second computer network communication requesting access to stored healthcare information for the individual, the second computer network communication corresponding to a second entity selected from among the plurality of designated entities, the second entity being different than the first entity;
refer to the hierarchy of rules in response to receiving the second computer network communication, the hierarchy of rules further indicating that a least a second subset of the healthcare information is accessible to the second entity, the at least a second subset of the healthcare information differing from the at least a first subset of the healthcare information; and
provide the at least a second subset of the healthcare information from storage to the second entity in accordance with the hierarchy of rules.

9. The computer program product of claim 8, wherein computer-executable instructions that, when executed, cause the computer system to store healthcare information for the individual at the computer system comprise computer-executable instructions that, when executed at a processor, cause the computer system to store one or more of: physiological data, medicine prescription data, medicine intake data, and electronic medical record data for the individual.

10. The computer program product of claim 9, wherein computer-executable instructions that, when executed, cause the computer system to store one or more of physiological data, medicine prescription data, medicine intake data, and electronic medical record data for the individual comprise: computer-executable instructions that, when executed, cause the computer system to store physiological data for the individual.

11. The computer-implemented method of claim 10, further comprising computer-executable instructions that, when executed, cause the computer system to, prior to storing physiological data for the individual, receive the physiological data directly from the one or more physiological data collection devices over a communication link, the communication link selected from among: a cellular network and a TCP/IP network.

12. The computer program product of claim 10, wherein computer-executable instructions that, when executed, cause the computer system to store physiological data for the individual at the computer system comprise computer-executable instructions that, when executed, cause the computer system to store one or more of: blood glucose data, heart rate data, Electrocardiography (“EKG”) data, weight data, temperature data, body mass data, and bone density data.

13. The computer program product of claim 8, wherein computer-executable instructions that, when executed, cause the computer system to receive first computer network communication comprise computer-executable instructions that, when executed, cause the computer system to receive a request to access the stored healthcare information from a family member of the individual; and
wherein computer-executable instructions that, when executed, cause the computer system to receive second computer network communication comprise computer-executable instructions that, when executed, cause the computer system to receive a request to access the stored healthcare information from a medical care provider of the individual.

14. The computer program product of claim 8, wherein computer-executable instructions that, when executed, cause the computer system to refer to a hierarchy of rules in response to receiving the first computer network communication comprise computer-executable instructions that, when executed, cause the computer system to refer to a hierarchy of rules that define a separate private collaborative network for each of a plurality of individuals that have healthcare information stored at the computer system.

15. A computer system, the computer system comprising:
one or more processors;
system memory;
one or more computer storage devices having stored thereon:
healthcare information for a plurality of different individuals, the healthcare information including collected physiological data received over communication links directly from one or more physiological data collection devices used by each of the plurality of different individuals;
a hierarchy of rules, the hierarchy of rules defining a separate private collaborative network for each of a plurality of different individuals, each private collaborative network defined by defining how the stored healthcare information for an individual can be shared among a plurality of designated entities; and
one or more computer-executable instructions representing a data access module, the data access module configured to:
receive requests from entities requesting access to stored healthcare information for an individual;
refer to the hierarchy of rules to determine what. if any, subset of the individual's stored healthcare information is accessible to the requesting entity; and
provide any accessible subset of stored healthcare information for the individual to the requesting entity in accordance with the hierarchy of rules.

16. The computer system of claim 15, wherein the healthcare information comprises medicine prescription data, medicine intake data, and electronic medical record data.

17. The computer system of claim 15, wherein collected physiological data is received over communication links selected from among: a cellular network and a TCP/IP network.

18. The computer system of claim 15, wherein the hierarchy of rules further defines risk management criteria for each of the plurality of different individuals, the risk management criteria defining when specified entities from among the plurality of designated entities are to be automatically notified about an individual's medical status; and
wherein the one or more computer storage media have further stored thereon one or more computer-executable instructions representing a risk management module, the risk management module configured to:
access healthcare information for an individual;
refer to the hierarchy of rules to access risk management criteria for the individual;
determine if healthcare information for the individual satisfies any access risk management criteria for the individual; and
automatically notify a corresponding specified entity when it is determined that a risk management criteria is satisfied.

19. The computer system of claim 15, wherein the risk management module being configured to automatically notify a corresponding specified entity comprises the risk management module being configured to send an alert to the corresponding specified entity.

20. The computer system of claim 15, wherein the risk management module being configured to automatically notify a corresponding specified entity comprises the risk management module being configured to send forecasting/tracking data to the corresponding specified entity.
